(19) United States
(12) Patent Application Publication
(10) Pub. No.: US 2011/0120166 A1
(43) Pub. Date: May 26, 2011

(54) CASING FOR HEATING/COOLING UNITS

(76) Inventors: Fredric NADEL, Westport, CT (US); Moshe Michael Siegel, Piermont, NY (US); Qianli Fu, Fort Lee, NJ (US)

(21) Appl. No.: 12/623,986

(22) Filed: Nov. 23, 2009

(51) Int. Cl. F25D 23/00; B23P 19/04

(52) U.S. Cl. 62/262; 29/700

(57) ABSTRACT

The present invention relates to cooling/heating units and their installation to wall or window openings, and more particularly pertains to a new and improved casing to secure the air conditioner while protecting against heat leakages through the casing itself. The wall casing is a cabinet structure containing a top side, a bottom side opposing the top side, and two opposing lateral sides being approximately orthogonal to the top and bottom sides. The top, bottom, and lateral sides forming substantially a box with the front and back opened. Each of the sides is double-walled and filled with an insulating material.

### FIELD OF THE INVENTION

The present invention relates to cooling/heating units and their installation to wall or window openings, and more particularly pertains to a new and improved casing to secure and seal the heating/cooling unit while protecting against heat exterior-to-interior (or vice versa) heat transfer and/or heat leakage through the sleeve itself.

### BACKGROUND OF THE INVENTION

The use of through the wall or window mounted air conditioning units is well known. These units are manufactured of varying cooling capacities between, for example, 6,000 BTU/hour through 36,000 BTU/hour ratings. Through-the-wall units , a subsection of which, when incorporating heating capabilities within the unit, are referred to as Packaged Terminal Air Conditioners (PTACs) and/or Packaged Terminal Heat Pumps (PTHPs), employ air intakes and exhaust on the rear (exterior) surface of the. Unit. Window mounted units employ similar rear air intake and exhaust, with the addition of side vents to enhance the air flow through the unit condenser section. Wall units and window units are typically inserted into a sleeve or casing of substantially the same dimensions (height and width) as the air conditioning unit. This sleeve is typically manufactured of a single layer of sheet metal, or to a much lesser extent, materials like fiber glass or aluminum, which allows for excessive heat transfer from the building exterior to the interior conditioned spaces (or vice versa) through the sleeve and the sleeve material. This decreases the energy efficiency of the cooling/heating unit, by allowing unwanted heat transfer. It additionally decreases the energy efficiency of the building itself.

Therefore, there remains a need for a through-the-wall or window sleeve or casing to that will prevent unwanted heat transfer while accommodating a cooling/heating unit in an energy efficient manner.

### SUMMARY OF THE PRESENT INVENTION

Accordingly, it is an object of the present invention to provide a new and improved air conditioner wall casing which may be easily and efficiently manufactured and marketed.

It is a further object of the present invention to provide a new and improved cooling/heating unit casing which is of a durable and reliable construction.

Another object of the present invention is to provide a new and improved air conditioner casing which is economical.

A yet further object of the present invention is to provide a casing for in-wall cooling/heating units, which effectively reduce heat transfer through the casing to allow more efficient units to be utilized in a through-the-wall installation. As such, the general purpose of the present invention is to provide a new and improved cooling/heating casing sleeve which has all the advantages of being able to secure heating/cooling units through-the-wall or window opening, and allow for the proper heat exchange between the unit and the outside air for proper unit functioning, and none of the heat transfer disadvantages.

The foregoing objects are accomplished by a wall casing or sleeve for a window or through-the-wall cooling/heating unit. The wall casing is a cabinet structure containing a top side, a bottom side opposing the top side, and two opposing lateral sides being approximately orthogonal to the top and bottom sides. The top, bottom, and lateral sides forming substantially a box with the front and back opened. Each of the sides is double-walled and filled with an insulating material. In a preferred embodiment, the insulation is selected from the group consisting of polyurethane, polypropylene, polyethylene, polystyrene, polyester, fiberglass, and combinations thereof. The walls of the casing is made of a metal, fiberglass, or plastic. Preferred metals are galvanized sheet metal, stainless steel, cold- or hot-rolled steel, or aluminum. The casing is dimensioned so that a cooling/heating unit can be inserted into the casing so that the back of the unit faces the outside of the wall while the front of the unit faces the interior of the wall to effect cooling and/or heating of the building's interior.

The present invention also relates to the use and manufacture of the wall casing for through-wall installations of cooling/heating units.

These together with other objects of the invention, along with the various features of novelty which characterize the invention, are disclosed with particularity in the claims annexed to and forming a part of this disclosure. For a better understanding of the invention, its operating advantages and the specific objects attained by its uses, reference should be made to the accompanying drawings and descriptive matter which illustrate preferred embodiments of the invention.

### BRIEF DESCRIPTION OF THE DRAWINGS

FIG. 1 is a drawing showing the heating/cooling units casing of the present invention.

FIG. 2 is a drawing showing the details of the double wall of the casing.

### DETAILED DESCRIPTION OF THE PREFERRED EMBODIMENTS

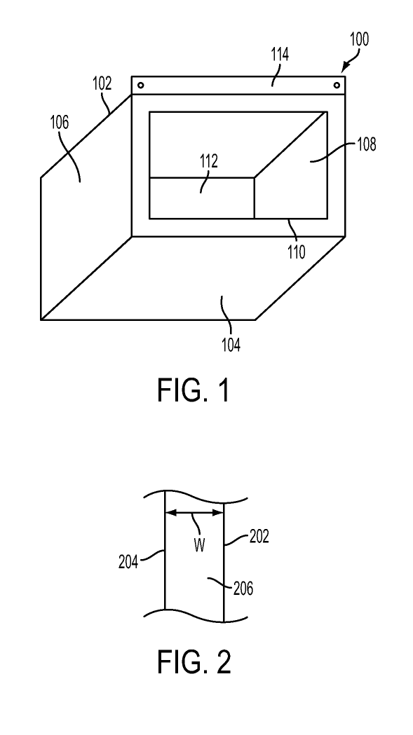

With reference now to the drawings, a new and improved casing for heating/cooling units embodying the principles and concepts of the present invention is described. More specifically, referring to FIG. 1, the heating/cooling unit casing 100 essentially comprises a structure formed with a top side 102, a bottom side 104, a first lateral side 106 orthogonally formed to the top side 102 and bottom side 104, and a second lateral side 108 parallel to said first lateral side 106. The fours sides together form a box with open front side 110 and back side 112. In use, the back side 112 is opened to the outside of the building, while the front side 110 is opened to the inside of the building.

The top 102, bottom 104, and lateral 106, 108 sides of the casing 100 are each preferably double walled. Referring to FIG. 2, which shows the double wall of each of the sides of the casing 100, each of the sides contains an inner wall 202 and an outer wall 204. The space 206 between the inner and outer walls is filled with an insulating material.

The inner 202 and outer 204 walls are preferably made of a structural material, such as metal, fiberglass, or plastic material. The preferred metals are sheet metal, preferably galvanized sheet metal, stainless steel, or cold- or hot-rolled steel, and aluminum. The space 206 between the inner 202 and outer 204 walls is preferably about 1/16 to ¾ inch in width (w), more preferably about ½ inch width.

The insulating material can be, but is not limited to, polyurethane, polypropylene, polyethylene, polystyrene, polyester, fiberglass, and combinations thereof, with polyurethane foam being the preferred material. In an embodiment, the insulating material is foam that can be sprayed into the space 206 between the walls 202, 204. The foam can either be an open cell or closed cell foam, however, for best insulation, closed cell foam is preferred. In this embodiment, the casing 100 first assembled into its final configuration. The foam is then sprayed into the space 206 to complete the casing.

In use, the casing 100 is inserted into a wall or window opening so that the outer wall 202 of the casing 100 is adjacent to and in contact with the wall or window frame. The front opening 110 is opened to the inside of the wall or window; and the back opening is opened to the outside of the wall or window. The sides, toward the front opening may contain a flange 114 for supporting and securing the casing to the wall or window. Although FIG. 1 shows the flange 114 as an extension of the top side 102 of the casing 100, this flange 114 can be extended off any of the other sides 104, 106, 108. To secure the casing 100 to the wall or window opening, fasteners, such as screws, nails, rivets, are used to fasten the flange 114 to the wall or window frame. Instead of fasteners, welding, glue, and adhesives may also be used to secure the flange 114 to the wall or window frame.

Once the casing 100 is secured to the wall or window, the cooling/heating unit is inserted into the casing 100 and is contained therein. Accordingly, it may be appreciated that the dimensions of the casing 100 may be provided of varying widths and heights to accommodate varying sized cooling/heating units. A typical cooling unit may have a size of about 42×16 inches, but other sizes may also be within the scope of the present invention. As with conventional window or wall air conditioning units, a series of louvers may be attached to the back 112 of the casing 100 to produced a finished look to the casing 100.

Additionally, the dimensions of the sides 106, 108 may be extended in length toward the back 112 beyond the inner casing and louvers. Openings may be punched in the sides 106, 108 within this extended area to allow additional cross flow ventilation through the rear section of the casing for use with window mounted units.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A wall or window casing for securing a heating/cooling unit comprising as structure having
a top side;
a bottom side;
a first lateral side orthogonally formed to the top side and bottom side; and
a second lateral side parallel to said first lateral side;
wherein each side is double walled and contain an insulating material within the double wall.

2. The casing of claim 1, wherein the double wall is formed by an outer wall and an inner wall containing the insulating material therebetween.

3. The casing of claim 1, wherein the walls are made of metal or plastic.

4. The casing of claim 3, wherein the metal is selected from the group consisting of aluminum, galvanized sheet metal, stainless steel, or cold- or hot-rolled steel.

5. The casing of claim 1, wherein the insulation is selected from the group consisting of polyurethane, polypropylene, polyethylene, polystyrene, polyester, fiberglass, and combinations thereof.

6. The casing of claim 1, wherein the front and back of the structure are opened.

7. The casing of claim 1, wherein louvers are attached to the back of the structure.

8. The casing of claim 1, wherein it is received in a wall or window opening.

9. The casing of claim 1, wherein the top, bottom, first lateral, and second lateral sides form an opening for receiving the heating/cooling unit.

10. A method for making a wall or window casing for securing a heating/cooling unit, said method comprising the step of
a. forming a structure having
i. a top side,
ii. a bottom side,
iii. a first lateral side orthogonally formed to the top side and bottom side, and
iv. a second lateral side parallel to said first lateral side, wherein each side is double walled; and
b. providing an insulating material within the double wall.

11. The method of claim 10, wherein the wherein the double wall is formed by an outer wall and an inner wall containing the insulating material therebetween.

12. The method of claim 10, wherein the walls are made of sheet metal.

13. The method of claim 10, wherein step b is accomplished by spraying the insulating material into the double wall.

14. The method of claim 10, wherein the insulation is selected from the group consisting of polyurethane, polypropylene, polyethylene, polystyrene, polyester, fiberglass, and combinations thereof.

15. The method of claim 10, wherein the front and back of the structure are opened.

16. A method for installing a cooling/heating unit in a wall opening or window, said method comprising the steps of
providing the casing of claim 1;
inserting the casing into the wall or window opening; and
inserting the cooling/heating unit into the casing.

17. The method of claim 16, further comprising the step of securing the casing to the wall or window opening.

18. The method of claim 17, wherein the securing step comprises fastening a flange on the casing to the wall or window frame.

19. The method of claim 16, wherein the wherein the double wall is formed by an outer wall and an inner wall containing the insulating material therebetween.

20. The method of claim 16, wherein the walls are made of sheet metal.
